(19) United States
(12) Patent Application Publication
(10) Pub. No.: US 2004/0222650 A1
(43) Pub. Date: Nov. 11, 2004

(54) Sanitary collection device

(76) Inventors: Anthony Colesanti, Philadelphia, PA (US); Nicholas Colesanti, Williamsport, PA (US)

Correspondence Address: Anthony Colesanti, Esquire, COLESANTI & ASSOCIATES LLC, Suite 1505, 117 North 15th Street, Philadelphia, PA, 19102, US

(21) Appl. No.: 10/431,840

(22) Filed: May 7, 2003

(51) Int. Cl. A01K 29/00; E01H 1/12

(52) U.S. Cl. 294/1.3

(57) ABSTRACT

The present invention is directed to a pet waste collection system for use with dogs, cats, and other pets to collect their solid waste. In one embodiment, the device includes a plurality of interconnected panels positioned to form a pair of hingedly connected claws, the claws together defining a contained space, and wherein each claw includes a main panel having three exterior side-edge panels extending outwardly therefrom, and an interior side-edge panel foldably connected to one of the exterior side-edge panels. The interior side-edge panel is provided with a locking tab which operatively engages a complementary locking slot provided along the fold line between the exterior side-edge panel and the main panel.

### BACKGROUND OF THE INVENTION

1. Field of the Invention

The present invention relates to collection of animal solid waste, and, more particularly for a system for collecting and securing animal waste of domesticated pets before it becomes an environmental/sanitation problem and/or a violation of law. More specifically, the present invention is directed to a combination device (system) for collecting pet waste, and for doing so in a clean, safe, elegant, discrete and efficient manner. The present invention system provides for compact storage, yet expandability for use, and enables a user to readily collect, transport and dispose the waste.

2. Description of Prior Art

The following patents illustrate various prior art devices and methods of collecting pet waste: U.S. Pat. No. 6,554,335 describes a pet waste collection system, which includes a main housing having a hollow inside and having a top, a bottom, a front, and a back and at least one sidewall, and having an opening accessible to the hollow inside area. There is also a telescopically extendable and contractible pole attached at a first end to the hollow inside area of the main housing and attached to a collapsible frame at its second end. The collapsible frame unfolds for a waste receptacle, i.e. a “pooper” bag, and is spaced behind the pet during defecation. In some embodiments, an attachment hook is located on said main housing for attachment thereof to a leash, a belt, or other attachable area or item.

U.S. Pat. No. 2,141,007 describes a shovel comprising walls forming an enclosure open at one end and closed at the opposite end, a sleeve rigid with the closed end of the shovel angularly and rearwardly therefrom, a pair of longitudinally spaced flanges integral with said sleeve, a collar rotatably mounted around the sleeve between said flanges and held from longitudinal movement thereby, a handle extending into and rigidly attached to said sleeve and projecting upwardly and rearwardly therefrom, and a rotary sleeve mounted on the outer end of said handle approximately at right angles to said first named sleeve and facilitating turning of the shovel to extend the open end thereof downwardly and discharge the contents therefrom.

U.S. Pat. No. 3,052,214 describes a disposable catcher for trapping and containing excrement and the like for disposal thereof, said catcher comprising, in combination, a bag holding and operating means comprising a stick, said stick comprising connecting rod and a connecting tubular rod holder disposed therearound to limit movement of said rod between a forward lid open and a rearward lid closed position, and a disposable bag readily detachably connected to said stick, said bag comprising a disposable bag body and a movable lid, said lid being readily detachably connected to said connecting rod and said bag body being detachably connected in supporting position to said connecting rod holder, whereby said lid can be moved to open and closed positions by movement of said connecting rod, said bag being readily detached from said stick by detachment of said lid and said bag body from said connecting rod and connecting rod holder, respectively.

U.S. Pat. No. 3,139,299 describes a refuse collector, comprising in combination: an elongated and vertically extending tube element, said tube having an outlet at the bottom thereof; an elongated element in longitudinal sliding in relationship and by the tube element, one of said elements being rigid and having a handle section for manipulating the collector; a bowl carried by and at the lower end of one of said elements; a scoop for the bowl; means for pivotally connecting the scoop to both of said elements; means coupling the upper end of the tube with a source of fluid; and a manually actuated valve carried by the tube for controlling the flow of liquid through the tube.

U.S. Pat. No. 3,281,178 describes a device for collecting and disposing of animal fecal matter, comprising, in combination, a handle, a first frame element, a second frame element, one end portion of said first frame element being spaced apart from and oppositely positioned with respect to one end portion of said second frame element, the other end portion of said first frame element being connected to said second frame element, said handle member being transversely positioned with respect to both said first frame element and second frame element and being connected to said connected first and second frame elements, and a bag member removably attached to said connected first and second frame elements at their respective one end portions spaced apart from and oppositely positioned with respect to each other, said bag member having a collar and a body portion integral with said collar, said collar being sealed to said body portion at least two opposite points thereof, each of said two opposite points being between said two spaced apart and oppositely positioned end portions of said first and second frame elements, said collar being positioned over said two spaced apart and oppositely positioned end portions of said first and second frame elements, said body portion being positioned between said first and second frame elements, whereby said device can be easily used without any fecal matter to be collected contacting the frame elements and whereby said bag member can be easily removed and then closed and sealed by raising and inverting one side of said collar.

U.S. Pat. No. 3,286,826 describes a portable combination flat package for use in removing dog refuse from an area in which it is deposited including: a flexible fibrous container in the form of a sack having an open end that is defined by first and second flat side walls, two end walls and a bottom, with said end walls and bottom having centrally disposed fold lines formed therein that extend the length thereof, and said first side wall includes as an integral part thereof an extension that projects beyond said open end, which container is selectively disposable in either a first position in which it is flattened, a second positioned in which it is expanded to receive dog refuse through said open end when said extension is placed in contact with the surface on which said refuse rests, and a third position in which said container is rolled upon itself with said refuse within the confines thereof, with said extension when said container is in said third position being wrapped thereabout to seal the same; a rectangular sheet of cardboard of substantial stiffness disposed within said container when in said first position to prevent lateral creasing of said container, which sheet has a plurality of spaced fold lines formed therein that extend longitudinally and transversely therein which aid in shaping said sheet into a scoop when said sheet is removed from said container, and when said sheet is so shaped it defines two parallel longitudinally extending flanged that act as stiffeners, in the use of said scoop to pick up refuse and deposit the same together with said sheet in said container when in said second position; and, tie means within said container in said third position for holding said container in said third position with said refuse and sheet within the confines thereof with said extension being wrapped around said container to seal the same.

U.S. Pat. No. 3,431,008 describes a portable scavenging apparatus for removing feces of animals and other untouchable objects comprising a box having an opening therein and a lid adapted to selectively close and open said opening, a stick having a first end mounted to a wall of said box, means for moving said lid selectively between its closed and open positions including a lever, a link, an arm, and a spring, said lever being pivotally mounted at a predetermined point intermediate its ends to said stick at a predetermined point adjacent the second end of said stick, a handle mounted in fixed position to said stick to provide a stationary member toward which one end of said lever may be manually pivoted, said spring being interposed between said handle and said lever to normally urge said one end of said lever away from said handle, said link being attached to the opposite end of said lever so as not to be moved away from said handle when said lever is manually pivoted toward said handle, said link being mounted to said arm and said arm being operative when said lever and said link are moved to move said lid between its closed and open positions.

U.S. Pat. No. 3,446,525 describes in a portable pickup device for grasping and transporting unclean material such as animal droppings and the like, said device having an elongated body provided with a handle at one end: pickup means carried at the other end of the body including a pair of pickup members in virtually parallel planes, said pair of pickup members including parallel bottom straight portions cooperable to move along a surface in close relation thereto whereby at least one straight portion is adapted to move beneath a dropping to be picked up, at least one of said pickup members being an open frame; means for moving at least one of the pickup members to and away from the other; and a disposable compliant wrapping means received and held on said pickup means with an opening at said bottom portions, the open frame pickup member being adapted to permit outward lateral displacement of said compliant wrapping means when a dropping is lifted by said straight portions of the pickup means for containing the dropping in said wrapping means at one side of the pickup means.

U.S. Pat. No. 3,560,039 describes an apparatus for handling and disposing of animal excrement and the like comprising in combination a tong member including a pair of levers pivotally connected together intermediate their ends, loop handle portions at one end of each of said levers, the other end of each of said levers having a transverse elongated scoop portion which curves concavely inwardly toward the opposite lever whereby said scoop portions form a closed-end scoop when said long end member is in the closed position, and tissue-retaining means on said tong member for retaining a package of tissues therein, said tissue retaining means including a receptacle connected to one of said pair of levers and a removable cover on said receptacle having an opening therein for the removal of tissues from said receptacle.

U.S. Pat. No. 3,606,436 describes a portable device for picking up objects underfoot comprising: a first assemblage including a first blade-like member secured to the lower end of a first operating rod and projecting angularly therefrom; a second assemblage including a second blade-like member secured to the lower end of a second operating rod and projecting angularly therefrom; hinging means pivotally interconnecting said first and second assemblages for pincers-like movement of said blade-like members upon manipulation of said operating rods; and, a bag having a portion of its open end detachably secured to said first blade-like member, another portion of its open end detachably secured to said second blade-like member, and a portion of its closed end detachably secured to one of said operating rods so that the inverted bag is selectively opened and closed by the pinchers-like movement of said blade-like members resulting from manipulation of said operating rods.

U.S. Pat. No. 3,659,891 describes a refuse collecting device having an improved tubular bag-mounting member at the lower end of a handle for collecting refuse such as animal leavings and the like. The refuse is collected in a disposable bag removably mounted on the tubular element in an improved manner for positive association with the tubular element during use while yet providing for facilitated withdrawal of the bagged matter in a sanitary manner.

U.S. Pat. No. 3,676,887 describes a flexible bag body portion that has a substantially rigid blade element permanently attached to one side wall thereof adjacent the open mouth of the bag body portion. A flexible closure flap is carried by the opposite side wall of the bag body portion and has an adhesive sealing area coact with a like area on the side wall of the body portion carrying the blade element. The bag is sealed with the litter and the blade element therein prior to disposal.

U.S. Pat. No. 3,716,263 describes a device for collecting articles and substances, comprising in combination: a handle; an adjustable shaft surmounted by said handle; a pair of outwardly inclined arms depending from said adjustable shaft; pivotal means depending from said arms; said pivotal means being normally maintained in an inclined, open position by spring means depending from said arms; said pivotable means being disposable into a horizontal, closed position when said pivotable means are in abutment with a surface and said handle is depressed; descendable means depending from said arms and contactable with said pivotable means when it is in said closed position, thereby obstructing the return of said pivotable means from said closed to said open position.

U.S. Pat. No. 3,757,737 describes a mechanical device for sequentially loading multiple bodies of animal dropping from the ground in to a disposable bag. The illustrated device has an elongated handle which carries a pickup means at its lower end. The pickup means includes means for releasably holding a bag with the mouth of the bag held open in a generally vertical plane, and a movable paddle proportioned and arranged to engage and propel a body of animal droppings into the bag through the open mouth. The movement of the paddle is remotely controlled from the upper end of the handle by a manually movable lever which is operable to impart a rapid propelling movement to the paddle.

U.S. Pat. No. 3,778,097 describes a device for retrieving litter that has manually actuated positioning means connected to a litter receptacle holder and a pushing member adapted to be enclosed in an envelope releasably secured about the pushing member. Actuation of the positioning means causes coaction between a litter receptacle mounted in the litter receptacle holder and the enveloped pushing member, so that litter is forced into the litter receptacle and held in the litter receptacle by the pushing surface. While the litter is being held within the litter receptacle by the enveloped pushing member, the envelope is released from about the pushing member and reversed to envelope the opening of the litter receptacle. The litter receptacle can then be manually ejected into the envelope when the positioning means are actuated to move the pushing member away from the litter receptacle.

U.S. Pat. No. 3,786,780 describes a portable canine toilet, in combination a holder and disposable waste receiving means adapted to be removably fitted upon the holder. The holder has a projecting means mounted on its rod portion, and the receiving means has a partially circumferential sleeve along its upper portion and into which the lower part of the holder is inserted. The receiving means also has a stringed collar at the top of the upper portion, the protruding portion of the string normally positioned on the projecting means.

U.S. Pat. No. 3,804,448 describes an elongated light weight shaft that has at one end a handgrip portion and at the other end a scavenging scoop receptacle with an inlet opening facing transversely of the length of the shaft. An electric light on or near the handgrip portion illuminates the receptacle inlet and the locale adjacent thereto. The implement may be manipulated by one hand of a user while the user is standing in his normal upright position. The scoop receptacle may include, or support, a detachable disposable container or liner. A closure lid is hingedly mounted relative to the scoop receptacle so that the lid can be moved into an open position while the receptacle is in scooping position and into closed position upon completion of the scooping operation, selectively, by manipulation of the shaft by the supporting hand of user. A pusher tool or brush is carried by the shaft near the receptacle. Propelling means are provided in the receptacle and are operable manually to propel the material scooped into the entry of the receptacle farther into the receptacle and away from the inlet opening so that the material can be carried in the receptacle without danger of spillage even with the shaft carried substantially upright.

U.S. Pat. No. 3,819,220 describes a sanitary device for pets which comprises a wand having at one end a pair of spring arms which normally are biased apart. A disposable receptacle having sleeve portions around its normally open top has such portions fitted on said arms to be held open thereby and positioned beneath a pet to receive feces as the latter is discharged. The receptacle is fitted on the arms; the arms squeezed together, the receptacle wrapped around the arms and a sleeve telescoped on the wand to retain the device in readiness. After use, the receptacle may be expelled from the arms by extending the sleeve.

U.S. Pat. No. 4,019,768 describes a device for sanitary pickup of ground deposited excrement comprises a metal frame structure having an excrement engaging pickup portion and a conventional bag supporting portion. Said bag holding portion positively retains a conventional shopping bag on the holding portion in a manner to hold the mouth of the bag open for ready reception of the said excrement together with additional structure supported by the handle for quick and easy release of said bag from positive retention on the support portion. Additional covers are also provided for the excrement engaging portion of the device to increase the usefulness of said device.

U.S. Pat. No. 4,215,887 describes a pickup device of highly functional yet inexpensive construction, comprising a pair of loop-shaped portions that are hinged together, with the loop-shaped portions being movable to a widely separated position such that an inverted bag that has been partially turned inside out may be inserted between the loops. Handle portions located above the hinge locations are able to be grasped by the user and brought together, with such action serving to bring base portions of the loops, as well as certain neck portions of the bag together. This action makes the device readily adaptable for the picking up of material from a floor or sidewalk, such as that deposited by an animal, with this arrangement advantageously serving to cause the removed material to be enveloped in the bottom portion of the bag, with the upper portions of the bag thereafter being easily brought together and tied, and with the exterior of the bag and the pickup device remaining unsoiled throughout the entire procedure.

U.S. Pat. No. 4,323,272 describes a hand portable and single hand operable device for picking up animal excrement and the like comprised of a pair of metal rods fixed close enough together at one end as V shaped extensions from a spring loop to form a handle portion for grasping with one hand about both rods which are deflectable toward each other by pressure of the hand. At the other end of each of the rods is a bag support member comprised of an elongated bag support wire loop formation having two substantially parallel width portions and two opposed length portions with length portions farthest from the handle portion in each bag support loop formation being straight and parallel to each other and moveable toward each other into line contact with each other by deflection of the rods. A bag having flexible sidewalls and an opening with a cuff is mounted on the respective bag support wire loop formation in a manner that the opening is at and controlled by the parallel straight portions of the bag support loop formations.

U.S. Pat. No. 4,341,410 describes a frame that comprises a handle and a pair of legs extending therefrom with the handle being substantially U-shaped and having a taut wire spanning the distal ends of the legs. A plastic or paper bag is engaged between the legs with one side of the open end folded over the taut wire and the legs and the forefinger of the hand holding the handle engaging the other side of the open end and tensioning the same against the wire. This holds the bag in the open position. The primary use is for scooping up waste material from animals such as dogs but it can also be used to hold a bag upright in the open position with one hand so that the bag can be filled with material by the other hand. It can also be used in industry for sanitary sampling of granular, comminuted, or liquid materials. In one embodiment the frame is foldable for easy storage.

U.S. Pat. No. 6,039,370 describes a portable pet toilet having an elongated pole having first and second ends. The first end provides a handle. Securely mounted on the second end of the pole is a pair of selectively adjustable arms for supporting a disposable receptacle. The arms are adjustable in order to provide the capability of accommodating receptacles of different sizes and shape.

Notwithstanding the prior art, the present invention is neither taught nor rendered obvious thereby.

### SUMMARY OF THE INVENTION

The present invention is directed to a collection and disposal device for animal waste. In one embodiment, the device includes a plurality of interconnected panels positioned to form a pair of hingedly connected claws, the claws together defining a contained space, and wherein each claw includes a main panel having exterior side-edge panels extending outwardly therefrom, and an integral interior side-edge panel. The interior side-edge panel may be provided with a locking tab which operatively engages a complementary locking slot provided along the fold line between the exterior side-edge panel and the main panel.

In one embodiment at least two side-edge panels are interconnected by a bellows fold for improved structural rigidity. A free edge of the bellows fold may optionally be provided with a locking tab for engagement with a corresponding locking slot provided at the fold-over position along the common edge of the exterior and interior side-edge panels.

In yet another embodiment, the collection device is impregnated with scents and anti-bacterial substances to reduce unpleasant odors and minimize environmental contamination.

Another aspect of the invention lies in a method for collecting waste material, which includes the step of grasping the waste material between a pair of hingedly attached claws formed of a plurality of interconnected paperboard panels.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a isometric view of an erected collection device according to the invention;

FIG. 2 is a top plan view of a flat blank of sheet material to be folded to form the collection device shown in FIG. 1;

FIG. 3 is a bottom plan view of the flat blank shown in FIG. 2;

FIG. 4 is a isometric view of the blank shown in FIG. 2 after certain of the folding operations;

FIG. 5 is a partial isometric view of the collection device shown in FIG. 1, illustrating certain fold panels and internal engaging structures;

FIG. 6 is a sectional view of the erected collection device shown in FIG. 1;

FIG. 7 is a sectional view of the erected collection device according to another embodiment of the invention;

FIG. 8 is a sectional view of the erected collection device according to yet another embodiment of the invention;

FIG. 9 is a partial isometric view of a collection device according to another embodiment of the invention, illustrating certain fold panels and internal engaging structures;

FIG. 10 is an isometric view of a collection device according to another embodiment of the invention, illustrating certain fold panels and engaging structures;

FIG. 11 is an isometric view of a collection device according to another embodiment of the invention, illustrating certain fold panels and engaging structures;

FIG. 12 is an isometric view of a collection device according to another embodiment of the invention, illustrating certain fold panels and engaging structures;

FIG. 13 is an isometric view of a collection device according to another embodiment of the invention, illustrating an internal baffle configuration; and

FIG. 14 is a sectional isometric view according to another embodiment of the invention, illustrating certain fold panels and engaging structures.

### DETAILED DESCRIPTION

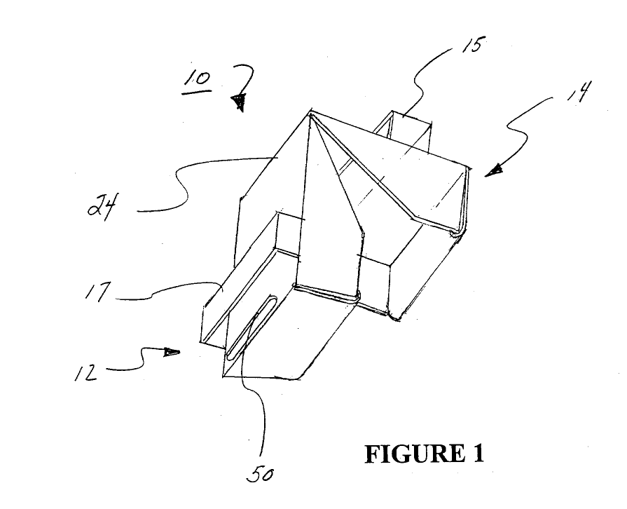

FIG. 1 shows a collection/disposal device, in an erected state, for collecting and disposing waste materials such as canine fecal matter in accordance with a preferred embodiment of the invention. The device 10 in the erected state defines a pair of opposed scoops or “claws” 12 and 14, which are hingedly connected along a fold line 24.

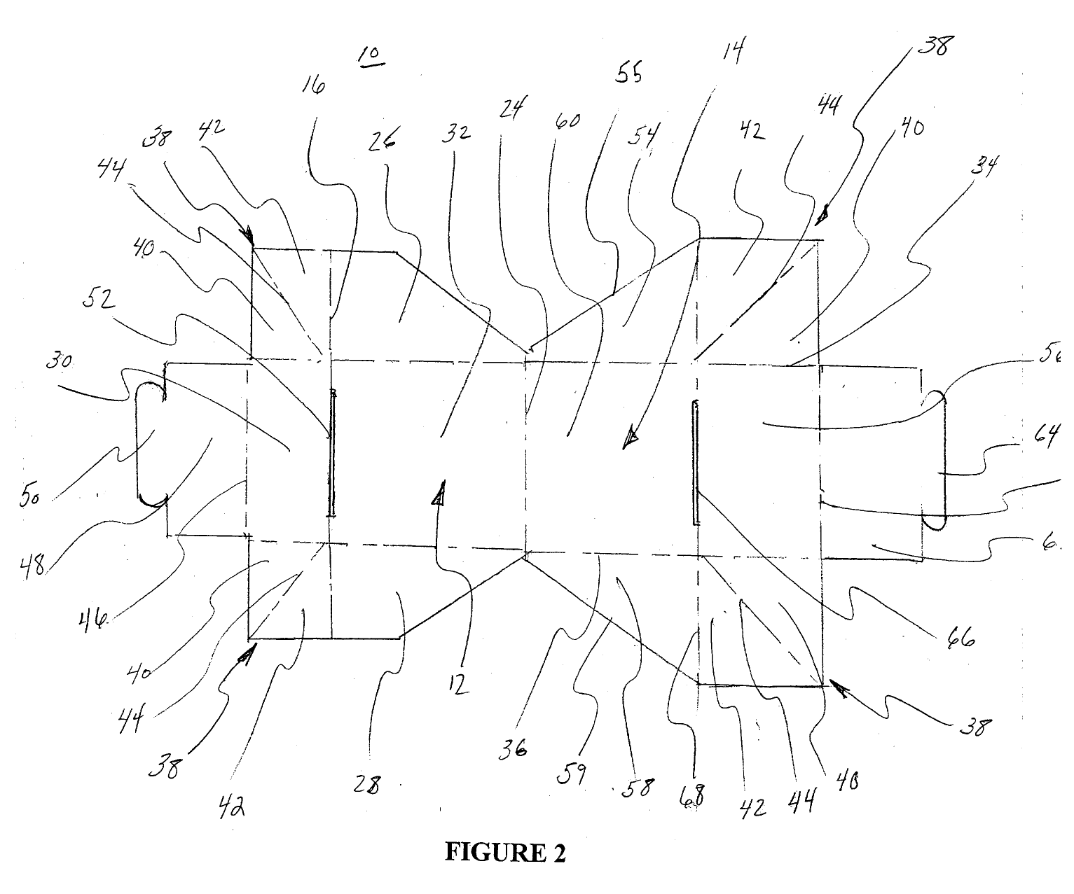

FIG. 2 shows the device in a knocked-down flat (KDF) configuration, as it appears after being cut from an integral piece of paperboard, corrugated craft or other foldable sheet material, commonly referred to as a “blank.” The paperboard may be waxed on one or both sides to improve performance and/or minimize leakage and deterioration of the device. Claw 12 in the embodiment shown includes three side-edge panels 26, 28 and 30, each panel being foldably connected along corresponding transverse or vertical fold lines to corresponding edges of a four-sided main panel 32. Advantageously, all the panels are integral portions of a single flat blank.

A number of thicknesses can be die cut in a single step. However, blanks preferably are cut out individually so that the blank can be scored or compressed along the lines that are to be folded, at the same time that the perimeter of the blank is cut from the sheet. Along certain lines the blank is folded when it is formed into a collapsed state for shipment, and other lines are folded or partially unfolded when the collapsed blank is erected for use. Lines representing fold or score lines are shown in the drawings by broken lines, and can be made by compressing the material along a line, cutting all or part way through the material at spaced intervals, cutting through part of the material thickness, etc.

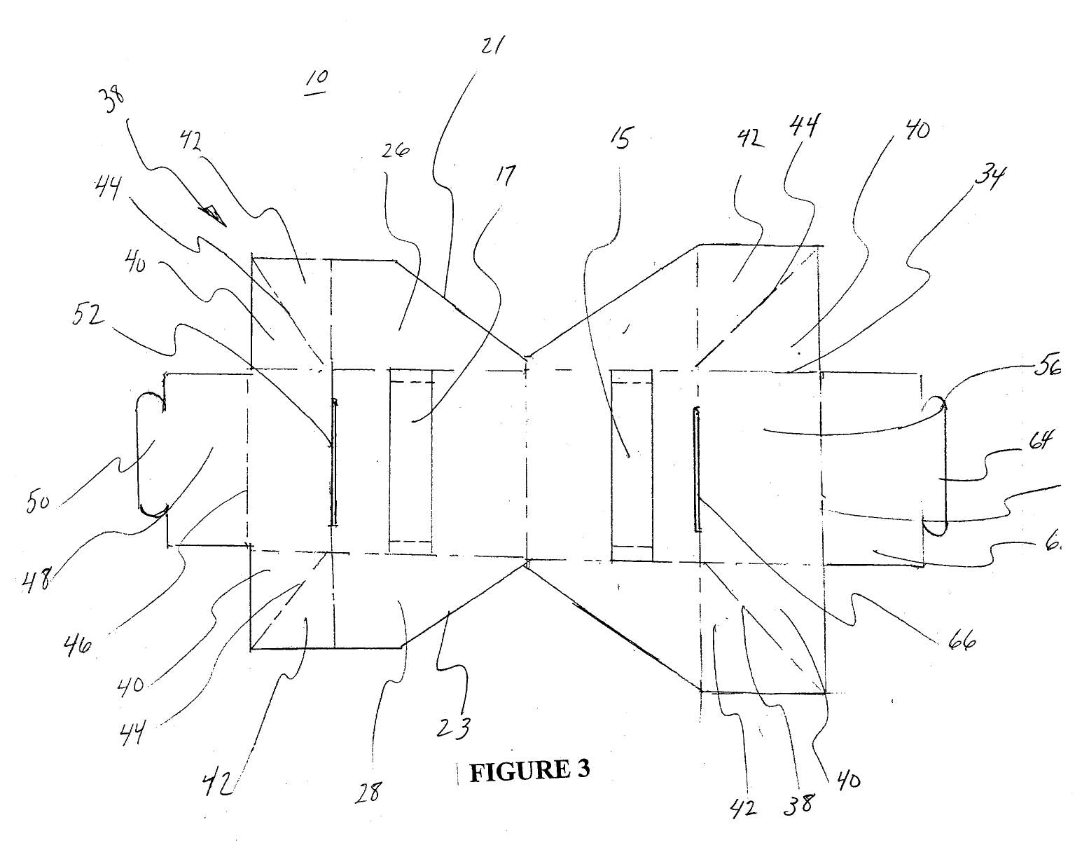

FIG. 3 shows a bottom plan view of the KDF configuration of FIG. 2. In this view, retainer straps 15 and 17 are shown connected to the bottom surface of the blank. When user engages the assembled device 10, the retainer straps 15 and 17 serve to operatively secure the device to a user's hand in order to facilitate manipulation of the device in retrieving and transporting articles contained therein.

Referring again to FIG. 2, side-edge panel 30 is further connected to side-edge panels 26 and 28 along fold lines 34 and 36, respectively, by a bellows fold panel 38. Each bellows fold panel 38 is formed from a pair of triangular panels 40 and 42, which are foldably connected along score line 44. As shown in FIG. 1 when the device is erected, panels 40 and 42 are folded inwardly of the claw 12 to form a bellows fold 38. Bellows fold structures 38 cause the side-edge panels to pull one another into an orientation perpendicular to a corresponding main panel during erection of the device 10.

In the erected state, side-edge panel 30 functions as an exterior edge panel of claw 12, and is further connected along fold line 46 to an interior side-edge panel 48. As shown in FIG. 1, when the device is erected, edge panel 48 is located interior to and in abutting relationship with edge panel 30. Edge panel 48 further includes a locking tab 50, which engages a complementary cutout 52 located along a corresponding edge of main panel 32. When assembled, bellows 18 are secured between interior and exterior side panels 30 and 48, and are secured by locking tab 50, thereby increasing the rigidity of claw 12.

Claw 14 is generally configured as a mirror image of claw 12, with claw 14 preferably having a slightly smaller footprint than claw 12, thereby allowing the free edges of claw 14 to be received interior to and in nested engagement with the side-edge panels 26, 28 and 30 of claw 12, whereby the engaged claws 12 and 14 together form a closed cavity for receiving, containing and transporting articles.

More specifically, claw 14 in the embodiment shown includes three side-edge panels 54, 56 and 58, each panel being foldably connected along transverse or vertical fold lines to corresponding edges of a four-sided main panel 60. Side-edge panels 54 and 58 each have a tapered free edge 55 and 59. Side-edge panel 56 is further connected to side-edge panels 54 and 58 along fold lines 34 and 36, respectively by a bellows fold panel 38. Side-edge panel 56 functions as an exterior edge panel of claw 14, and is further connected along fold line 60 to an interior side-edge panel 62. As shown in FIG. 1, when the device 10 is erected, edge panel 62 is located interior to and in abutting relationship with edge panel 56. Edge panel 62 further includes a locking tab 64, which engages a complementary cutout 66 located along a corresponding edge of main panel 60. When assembled, bellows 18 are secured between interior and exterior side panels 62 and 56, and are secured by locking tab 50.

A collection device 10 may be provided in a range of sizes to accommodate particular uses. In one embodiment, the collection device 10 in a closed configuration has a maximum width of about 4 inches, a length of about 4 inches and a height of about 4 inches.

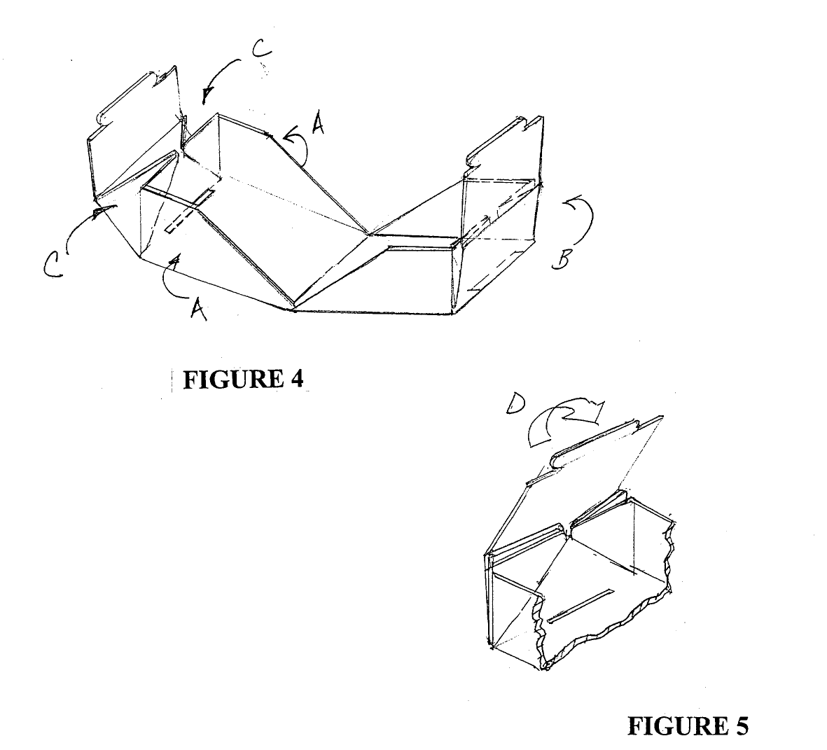

FIGS. 4-6 show the device 10 in progressive stages of erection and assembly. In FIG. 4 the blank has been folded along score lines 16, 34, 36 and 68, in the general directions indicated by arrows A and B, and bellows 38 are folded to collapse inwardly in the general direction shown by arrows C. Interior side-edge panels 48 and 62 are then folded inwardly about score lines 46 and 60, respectively, in the direction shown by arrow D in FIG. 5. Locking tabs 50 and 64 are engaged with respective complementary locking slots 52 and 66.

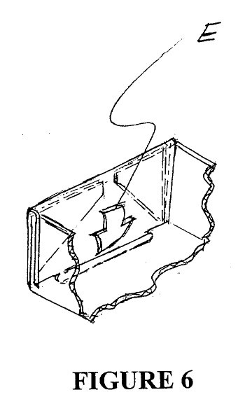

As best illustrated with reference to FIG. 6, the erected exterior and interior edge panels straddle respective bellows folds of each claw. The mechanical locking of the respective tabs and slots as illustrated by arrow D, together with the interior and exterior edge panels as well as the multiple layers of the of material at the bellows folds, form rigid claws having substantial resistance to lateral deformation.

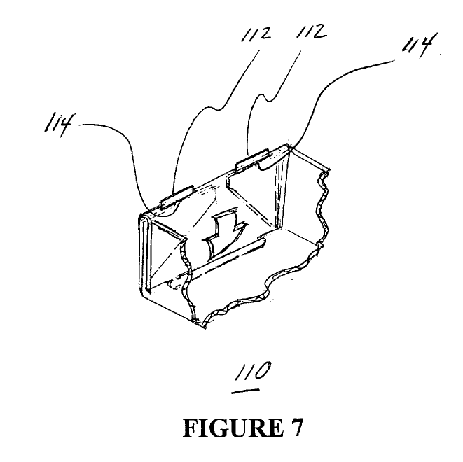

FIG. 7 shows another embodiment of the collection device 110, wherein locking tabs 112 provided at a free edge of the bellows folds 38 engage corresponding locking slots 114 provided along the fold line between the interior side-edge panel and an exterior side-edge panel.

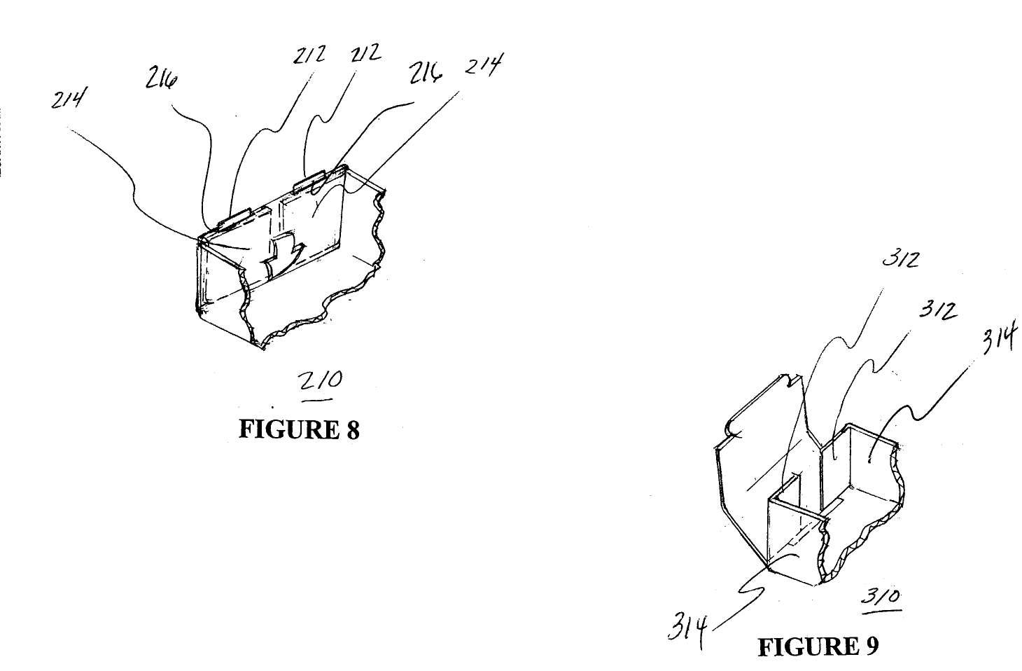

FIG. 8 illustrates another inventive aspect of the collection device 210 wherein locking tabs 212 provided at a free edge of side-edge panels 214 engage corresponding locking slots 216 provided along the fold line between the interior side-edge panel and an exterior side-edge panel.

FIG. 9 illustrates another inventive aspect of the collection device 310 wherein reinforcing side-edge panels 312 are foldably connected side-edge panels, in lieu of bellows folds.

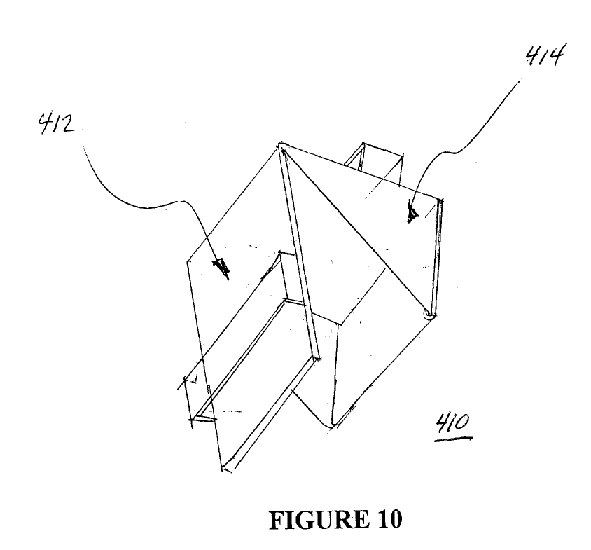

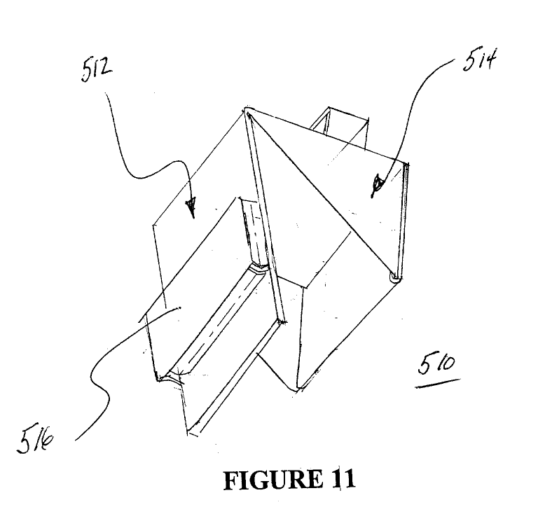

FIG. 10 shows another embodiment of the device 410, wherein a single scoop or “claw” 414 is employed, which is hingedly connected to a substantially flat panel 412. Panel 412 functions as a lid and operates in conjunction with claw 414 to provide a closed containment receptacle for collected materials.

FIG. 11. shows another embodiment wherein a claw 514 and panel 512 are hingedly connected to form the containment device 510, and a collapsible pocket 516 is provided on an outer surface of panel 512 for securing and protecting the user's fingers.

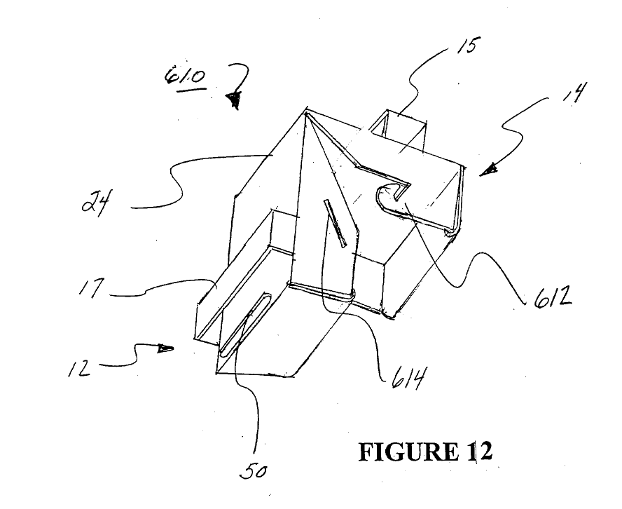

In another embodiment of the device 610, shown in FIG. 12, locking tabs 612 and complementary locking slots 614 are provided on the corresponding side-edge panels of a pair of hinged claws 616 and 618. Thus configured, the claws may be “locked” together once the waste is collected therebetween to facilitate transport and disposal thereof.

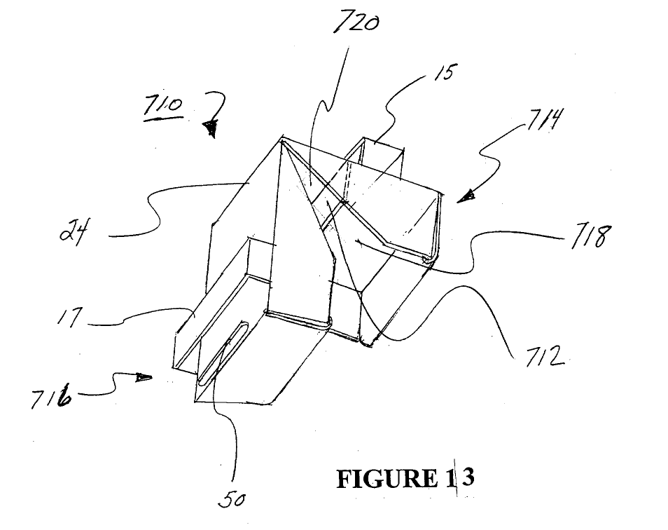

According to another inventive aspect, shown in FIG. 13, the device 710 may include one or more interior baffles 712, which extend from and perpendicular to one or both of the main claw panels 714 and 716. The baffles can be used to compartmentalize the device 710, such that waste may be collected according to a two-step procedure wherein waste initially collected in a lower receptacle 718 is moved to an upper receptacle 720 by temporarily inverting the device and separating the claws until the waste passes the baffles and is received in an upper “chamber.” A second collection can then be made reusing the lower chamber.

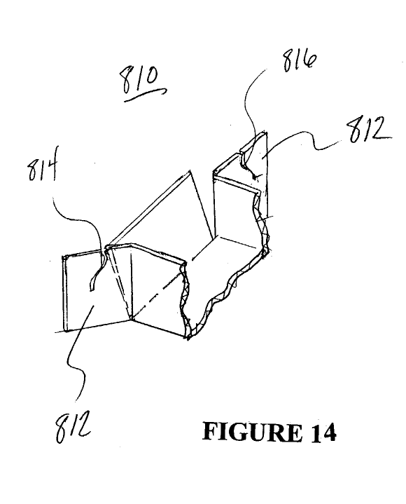

FIG. 14 illustrates a further embodiment of the invention in which two side edge panels 812 have complementary engaging features 814 and 816 that retain the two side-edge panels in an orientation that is substantially perpendicular to the main panel, when the device 810 is erected. It will be appreciated that other known complementary engaging features may also be employed.

In yet another embodiment, an anti-bacterial product is impregnated in or applied to select surfaces of the device in order to minimize contamination to the user and/or surroundings. Similarly, it is contemplated that scents or odor absorbent products may be impregnated in or applied to surfaces of the device in order to mask or remove malodorous scents.

It is further contemplated that the device can also be used in industry for sanitary sampling of granular, comminuted, or liquid materials.

### Exemplary Advantages of the Invention

A number of notable advantages are achieved in accordance with the present invention. For example, the collection device described herein may be inexpensively formed of a biodegradable paperboard, thus eliminating the need for non-degradable plastic bags heretofore employed for collecting waste. The device is collapsible to a substantially flattened state and, therefore, can be discretely carried in a clothes pocket or a small handbag. The collection device can be impregnated with scents or odor absorbing substances to reduce unpleasant odors. Anti-bacterial substances may also be integrated to minimize the opportunity for contamination of the user or waste receptacles into which the collected material and device are deposited. Unlike plastic bags and other known implements, the instant device is particularly well suited for single-handed use. Finally, the device does not require the user's hand to come into intimate contact with and/or conform to the collected waste, as encountered when using a plastic bag. Thus, the user does not experience the uncomfortable squishy, warm sensation typically associated with the use of plastic or paper bag collection devices.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A device for collecting waste comprising: a plurality of interconnected panels positioned to form a pair of hingedly connected claws, wherein the claws together define a contained space, wherein at least one claw includes a main panel having exterior side-edge panels extending outwardly therefrom.

2. A device for collecting, transporting and storing or disposing articles comprising a plurality of interconnected panels positioned to form a pair of hingedly connected claws, wherein the claws together defined a contained space, wherein each claw includes a main panel having three exterior side-edge panels extending outwardly therefrom, and an interior side-edge panel foldably connected to one of the exterior side-edge panels, wherein the interior side-edge panel includes a locking tab that engages a locking slot provided in the main panel.

3. The device of claim 1 further comprising a bellows fold connecting two exterior side-edge panels.

4. The device of claim 2 wherein the bellows fold includes a locking tab that engages a locking slot located along the fold line between the interior side-panel and the exterior side-edge panel.

5. The device of claim 2 wherein the device is scented.

6. The device of claim 2 wherein the device includes anti-bacterial product.

7. The device of claim 2 wherein the device is biodegradable.

8. The device of claim 2 wherein the device is plastic.

9. The device of claim 2 wherein one of the exterior side-edge panels is perforated.

10. The device of claim 2 wherein each claw further comprises a restraining strap.

11. The device of claim 2 wherein the device is collapsible.

12. The device of claim 3 wherein the bellows fold includes a locking tab that engages a locking slot located along the fold line between the interior side-panel and the exterior side-edge panel.

13. The device of claim 2 further comprising a reinforcing panel hingedly connected to one of the side-edge panels.

14. The device of claim 2 further comprising a baffle extending outwardly from an interior surface of one of the main panels.

15. The device of claim 1 wherein the at least one claw further comprises at least one integral, interior side-edge panel.

16. A method for collecting waste material comprising the step of:
grasping the waste material beween a pair of hingedly attached claws formed of a plurality of interconnected paperboard panels.

17. The method of claim 16 wherein at least one of the claws includes a main panel having three exterior side-edge panels extending outwardly therefrom, and an interior side-edge panel foldably connected to one of the exterior side-edge panels.
